(19) United States
(12) Patent Application Publication
(10) Pub. No.: US 2005/0289053 A1
(43) Pub. Date: Dec. 29, 2005

(54) METHOD AND SYSTEM FOR DISTRIBUTING PAYMENTS THROUGH AN ONLINE KIOSK

(75) Inventor: Mark Ruttenberg, Bloomington, IL (US)

Correspondence Address: BLACKWELL SANDERS PEPER MARTIN LLP, 720 OLIVE STREET, SUITE 2400, ST. LOUIS, MO, 63101, US

(73) Assignee: Monarch Visual Solutions, Inc., Normal, IL (US)

(21) Appl. No.: 11/160,474

(22) Filed: Jun. 24, 2005

Related U.S. Application Data
(60) Provisional application No. 60/521,748, filed on Jun. 29, 2004.

(51) Int. Cl. G06F 17/60; H04K 1/00; H04L 9/00

(52) U.S. Cl. 705/40; 705/64

(57) ABSTRACT

This invention relates generally to the distribution of payments, e.g., discounts, credits and/or debits, in a computer network environment. More specifically, the invention is directed to the distribution of payments, e.g., discounts, credits and/or debits, to a number of participants in a given transaction. Such participants include retail establishments, customers, and a kiosk or terminal-operating service provider. Predetermined payment, e.g., discount, credit and/or debit, amounts are electronically distributed and/or credited to the participants. In addition to traditional user interface techniques, an electronic identification device is provided by the system and method of the present invention for customer and distribution payment, e.g., discount, credit and/or debit, identification. Kiosk processors or remote processors facilitate purchasing and distribution of payments, e.g., discounts, credits and/or debits, to a local retailer and customers purchasing from the local retailer through unrelated catalog providers.

### CROSS-REFERENCE TO RELATED APPLICATION

This patent application claims priority to U.S. Provisional Patent Application Ser. No. 60/521,748 filed Jun. 29, 2004, the disclosure of which is incorporated herein by reference.

### BACKGROUND OF THE INVENTION

Coupon, sales, and loyalty programs have been provided to entice, reward, and encourage customers to spend. A common denominator for all of these programs is the payment, which may be in the form of a discount, credit and/or debit, to customers. These incentive programs require a system and methodology for tracking, policing and distributing proceeds. Traditionally, such incentives are spearheaded by manufacturers, distributors and/or retailers. There is typically a myriad of methods that exist for the distribution of these incentives. Since most purchasing occurs at a retailer establishment, retailers have traditionally had to coordinate the delivery of the discount, credit and/or debit to the customer along with the collection and/or debits to distributors or manufacturers. The proliferation of nontraditional retail sources, including non-brick and mortar cyber stores, and catalog house sales, provide new challenges for achieving the goal of increased customer spending.

While coupons and other such incentive programs continue to exist, it has become increasingly difficult to apply and implement them across the various customer retail interfaces. Individual retailers and in some cases groups of retailers have banded together to provide certain discount, credit and/or debit or loyalty programs to overcome some of the problems inherent to traditional coupon or discount, credit and/or debit systems. However, these affiliated retailers do not receive any pass-through benefits. For example, a customer may buy into a club membership that would provide discounts and/or credits at a number of retail or dining locations. Even so, the retailer has neither the incentive nor the motivation to aid the customer in making a purchase from the retailer. As a result, some retailers, such as grocery stores, provide a loyalty-based system that rewards and extends special privileges to customers who register and carry around the requisite membership cards for their chain of stores only. In any of these and other similar types of programs, the customer is faced with having to track and convey registration information that is unique to each of these locations or programs.

A major problem facing retailers is the arrival of the mega/super store that sells a wide spectrum of products to the customer. The buying power of these entities places retail establishments that sell a narrow range of products, e.g., grocery stores selling food, at a tremendous competitive disadvantage. Customers prefer doing all of their shopping at one location for reasons of both cost and convenience. Also, catalog houses that operate with a physical location and/or a global computer network, e.g., Internet, have a much more difficult time establishing a marketing presence due to the proliferation of entities operating in this area.

The present invention is directed to overcoming one or more of the problems set forth above.

### SUMMARY OF INVENTION

This invention relates generally to the distribution of payments, e.g., discounts, credits and/or debits, in a computer network environment. More specifically, the invention is directed to the distribution of payments, e.g., discounts, credits and/or debits, to a number of participants in a given transaction. Such participants include retail establishments, customers, and a kiosk or terminal-operating service providers. Predetermined payment amounts are preferably electronically distributed and/or credited to all of the participants. In addition to traditional user interface techniques, an electronic identification device, e.g., electronic card, inputted password, and so forth, may be provided by the system and method of the present invention for customer and distribution payment, e.g., discount, credit and/or debit, identification. Kiosk processors or remote processors facilitate purchasing and distribution of payments, e.g., discounts, credits and/or debits, to a local retailer and customers purchasing from the local retailer from unrelated catalog houses.

There is provided in the practice of the invention, a distribution of payments, e.g., discounts, credits and/or debits, to one or more entities including a retail establishment, a customer, and a service provider. In an embodiment of the present invention, predetermined payment, e.g., discount, credit and/or debit, amounts are electronically distributed and/or credited to one or more of the aforementioned entities.

In another aspect of the present invention, electronic identification device, e.g., electronic card, inputted password, and so forth, may be provided for interface by a customer. Through the information obtained from the electronic identification device, e.g., electronic card, inputted password, and so forth, relevant data items can be provided to a retail cashier along with all other entities processing the transaction. Even further, the electronic identification device, e.g., electronic card, inputted password, and so forth, allows a customer to utilize a home computer, telephone, or other means to shop and possibly obtain payments, e.g., discounts, credits and/or debits.

In yet another aspect of the present invention, a method for ordering items from a kiosk at a retail establishment is disclosed. This method includes electronically ordering at least one product through a kiosk processor located at a retail establishment having a first physical location from at least one catalog server located at a second physical location, wherein the at least one product is unrelated to the goods sold at the retail establishment.

Another aspect of the present invention is a system for ordering items from a kiosk at a retail establishment. This system includes a kiosk processor located at a retail establishment having a first physical location that is electronically connected from at least one catalog server located at a second physical location for ordering at least one product is unrelated to the goods sold at the retail establishment.

Yet in another aspect of the present invention, a method for distributing payments, e.g., discounts, credits and/or debits, is disclosed. This method includes ordering goods from at least one catalog server from either a kiosk processor located in at least one retail establishment, e.g., grocery store, or a remote processor, wherein each transaction provides a total predetermined payment, e.g., discount, credit and/or debit, through a transaction processor, electronically distributing a first predetermined payment, e.g., discount, credit and/or debit, of the total predetermined payment, e.g., discount, credit and/or debit, to a service provider that is responsible for the operation of the kiosks, transaction servers and/or terminals, electronically distributing a second predetermined payment, e.g., discount, credit and/or debit, of the total predetermined payment, e.g., discount, credit and/or debit, to at least one retail establishment, e.g., grocery store, and electronically distributing a third predetermined payment, e.g., discount, credit and/or debit, of the total predetermined payment, e.g., discount, credit and/or debit, to at least one customer for purchases at the retail establishment at a point-of-sale (POS) terminal.

An alternative method for distributing payments, e.g., discounts, credits and/or debits, is disclosed. This method includes ordering goods from at least one catalog server from either a kiosk processor located in at least one retail establishment, e.g., grocery store, or a remote processor, wherein each transaction provides a total predetermined payment, e.g., discount, credit and/or debit, through a transaction processor, electronically distributing a first predetermined payment, e.g., discount, credit and/or debit, of the total predetermined payment, e.g., discount, credit and/or debit, to at least one retail establishment, e.g., grocery store, and electronically distributing a second predetermined payment, e.g., discount, credit and/or debit, of the total predetermined payment, e.g., discount, credit and/or debit, to at least one customer for purchases at the retail establishment at a point-of-sale (POS) terminal. This is where the at least one retail establishment and/or the at least one catalog provider performs the function of being responsible for the operation of the kiosks, transaction servers and/or terminals.

In another aspect of the present invention, a system for distributing payments, e.g., discounts, credits and/or debits, is disclosed. This system includes at least one catalog server that electronically receives orders for goods from either a kiosk processor located in at least one retail establishment, e.g., grocery store, or a remote processor, a transaction processor for electronically distributing a total predetermined payment, e.g., discount, credit and/or debit, with a first predetermined payment, e.g., discount, credit and/or debit, of the total predetermined payment, e.g., discount, credit and/or debit, being provided to a service provider, a second predetermined payment, e.g., discount, credit and/or debit, of the total predetermined discount, credit and/or debit being provided to at least one retail establishment, e.g., grocery store, and a third predetermined discount, credit and/or debit of the total predetermined discount, credit and/or debit being provided to at least one customer for purchases at a point-of-sale (POS) terminal located at the retail establishment, e.g., grocery store.

An alternative system for distributing payments, e.g., discounts, credits and/or debits, is disclosed. This system includes at least one catalog server that electronically receives orders for goods from either a kiosk processor located in at least one retail establishment, e.g., grocery store, or a remote processor, a transaction processor for electronically distributing a total predetermined payment, e.g., discount, credit and/or debit, with a first predetermined payment, e.g., discount, credit and/or debit, of the total predetermined payment, e.g., discount, credit and/or debit, being provided to at least one retail establishment, e.g., grocery store, and a second predetermined payment, e.g., discount, credit and/or debit, of the total predetermined payment, e.g., discount, credit and/or debit, being provided to at least one customer for purchases at a point-of-sale (POS) terminal located at the retail establishment, e.g., grocery store. This is where the at least one retail establishment and/or the at least one catalog provider performs the function of being responsible for the operation of the kiosks, transaction servers and/or terminals.

In an aspect of the present invention, an electronic identification device, e.g., electronic card, inputted password, and so forth, wherein the electronic media is electronically connected to a kiosk processor and/or the point-of-sale (POS) terminal to provide a mechanism for identifying the customer. Preferably, but not necessarily, the amount of the third predetermined payment, e.g., discount, credit and/or debit, available to the customer at a point-of-sale (POS) terminal located at the retail establishment, e.g., grocery store, can be read and written to the electronic identification device, e.g., electronic card, inputted password, and so forth.

In another aspect of the present invention, the electronic ordering is preferably, but not necessarily, conducted through a computer network, e.g., a global computer network such as the Internet.

In a further aspect of the present invention, customers are able to utilize online kiosks or terminals for purchasing goods and services. Such kiosks or terminals are connected to a computer network and also provide access to products from unrelated catalog providers.

In a still further aspect of the present invention, an installation is provided for installing kiosk processors or point-of-sale (POS) terminals at a retailer's physical location. The installation comprises at least the integration of the kiosk with the retailer's point-of-sale (POS) terminals.

These are merely some of the innumerable aspects of the present invention and should not be deemed an all-inclusive listing of the innumerable aspects associated with the present invention. These and other aspects will become more apparent to those skilled in the art in light of the following disclosure and accompanying drawings.

### BRIEF DESCRIPTION OF THE DRAWINGS

For a better understanding of the present invention, reference may be made to the accompanying drawings in which:

FIG. 1 is a functional network diagram of a typical server environment in accordance with the present invention with a separate kiosk processor, catalog server and transaction server;

FIG. 2 is a functional network diagram of a typical server environment in accordance with a first alternative embodiment of the present invention with a kiosk processor and a combination catalog server and transaction server;

FIG. 3 is a functional network diagram of a typical server environment in accordance with a second alternative embodiment of the present invention with a catalog server and a combination kiosk processor and transaction server;

FIG. 4 is a diagram of an exemplary system for implementing a system for distributing payments, e.g., discounts, credits and/or debits, in accordance with the present invention; and

FIG. 5 is a flow diagram that illustrates a process for distributing payments, e.g., discounts, credits and/or debits, in accordance with the present invention.

### DETAILED DESCRIPTION OF THE INVENTION

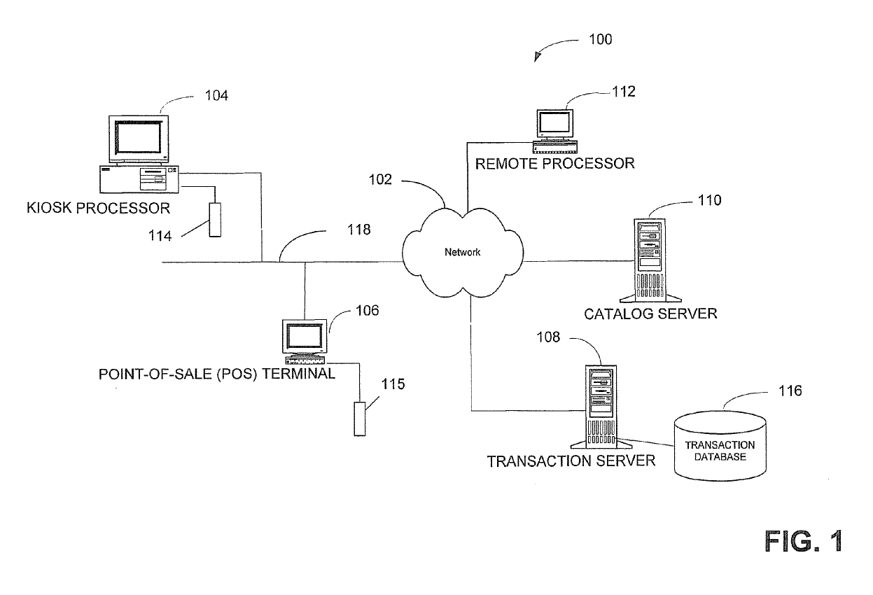

In the following detailed description, numerous specific details are set forth in order to provide a thorough understanding of the invention. However, it will be understood by those skilled in the art that the present invention may be practiced without these specific details. In other instances, well-known methods, procedures and components have not been described in detail so as to obscure the present invention. According to the embodiment(s) of the present invention, various views are illustrated in FIGS. 1-5, wherein like reference numerals are being used consistently throughout to refer to like and corresponding parts of the invention for all of the various views and figures of the drawing. Also, please note that the first digit(s) of the reference number for a given item or part of the invention should correspond to the FIG. number in which the item or part is first identified.

The present invention is directed to a system and method for the distribution of payments, e.g., discounts, credits and/or debits, in a network environment to a number of entities. In an embodiment of the present invention, varying percentages of payments, e.g., discounts, credits and/or debits, are allocated and distributed and/or credited from the purchasing of goods by a customer from a catalog server through either a kiosk processor that is physically located at an at least one retail establishment or a remote processor, e.g., home computer.

In an illustrative, but nonlimiting example, there is a total predetermined payment, e.g., discount, credit and/or debit of 10%, which is provided by a catalog provider through a computer network. This payment, e.g., discount, credit and/or debit, is distributed and/or credited electronically three (3) ways. The kiosk/terminal service provider that is responsible for the operation of the kiosks or terminals would receive a first predetermined payment, e.g., discount, credit and/or debit of 2%, the retail establishment, e.g., grocery store, would receive a second predetermined payment, e.g., discount, credit and/or debit of 3%, and the customer would receive a third predetermined payment, e.g., discount, credit and/or debit, of 5%, for purchases at the retail establishment by means of a point-of-sale (POS) terminal. Payments can include virtually any form of remuneration including cash, electronic fund transfers, coupons, and so forth. Preferably, but not necessarily, payments can be in the form of credits where the actual monetary transfer is not made until after a predetermined period of time.

In an alternative, but nonlimiting example, there is a total predetermined payment, e.g., discount, credit and/or debit of 10%, that is provided by the catalog provider through a computer network. This payment, e.g., discount, credit and/or debit, is distributed and/or credited electronically two (2) ways. The retail establishment, e.g., grocery store, would receive a first predetermined payment, e.g., discount, credit and/or debit of 5%, and the customer would receive a second predetermined payment, e.g., discount, credit and/or debit of 5%, for purchases at the retail establishment at a point-of-sale (POS) terminal. This is where the at least one retail establishment and/or the at least one catalog provider performs the service provider function of being responsible for the operation of the kiosks, transaction servers and/or terminals.

Briefly described, the system and method of the present invention provides in the course of a retail transaction, means to identify a customer and ascertain an associated and predetermined payment, e.g., discount, credit and/or debit level, as provided through a computer network, e.g., global computer network such as the Internet. Furthermore, the present invention provides the payment, e.g., discount, credit and/or debit level, information to a retailer who will consummate the transaction. Even further, the present invention provides for the electronic distribution of a predetermined payment, e.g., discount, credit and/or debit percentages, to the retailer and a kiosk or terminal service provider, in addition to the customer. In another embodiment of the present invention an interface to a retailer's point-of-sale (POS) terminal is also provided.

In yet another embodiment, an electronic identification device, e.g., magnetic card, is provided as an interface and method for communicating customer related information to the system and method of the present invention. Even further still, the present invention provides retail access to unrelated catalog providers from a kiosk or terminal located at a retail establishment or from a customer's home computer system.

Having briefly provided an overview of the present invention, a preferred embodiment of the invention will be discussed with reference to FIGS. 1, 4 and 5. An exemplary operating environment for the present invention is first described below.

The details of the invention and various embodiments can be better understood by referring to the figures of the drawing. Referring initially to FIG. 1, a functional network diagram of a typical client—server environment 100 implementing a kiosk processor 104 is shown. As shown, a network 102 may have various connected components including a kiosk processor 104, a point-of-sale (POS) terminal 106, a transaction server 108, a transaction database 116, a server 110 and/or a remote processor 112. The client server environment 100 should not be interpreted as having any dependency or requirement relating to any one or combination of components illustrated in the exemplary operating environment.

The network 102 may include a local area network (LAN), a wide area network (WAN) or other networks including a global computer network, e.g., Internet. When the network is a LAN, the kiosk processor 104, the point-of-sale (POS) terminal 106 or any of the other devices are connected to the network via a network interface card (NIC) or adapter. When used in a WAN networking environment, the devices may include a modem or other interface means for establishing communications over the WAN. It should be understood that in a networked environment, program modules discussed or depicted relative to the kiosk processor 104, point-of-sale (POS) terminal 106, remote processor 112 or servers 108, 110, or portions thereof, may reside in remote memory storage or across multiple devices such as a whole series of processors. Moreover, the terms “servers” and “processors” are used interchangeably throughout this application. Preferably, remote processor 112 and point-of-sale (POS) terminal 106 are personal computers; however, a wide variety of electronic computers or electronic controllers will suffice. It will be appreciated that the network connections 118 shown are exemplary and other means of establishing a communications link between the computing devices may be used. Moreover, the function of the transaction server 108 with associated payment database 116 as well as the server 110 can be combined with servers or processors associated with the catalog provider or an entity associated with the retail establishment. The illustrated devices and components may also be connected through wireless interfaces without departing from the scope of the present invention.

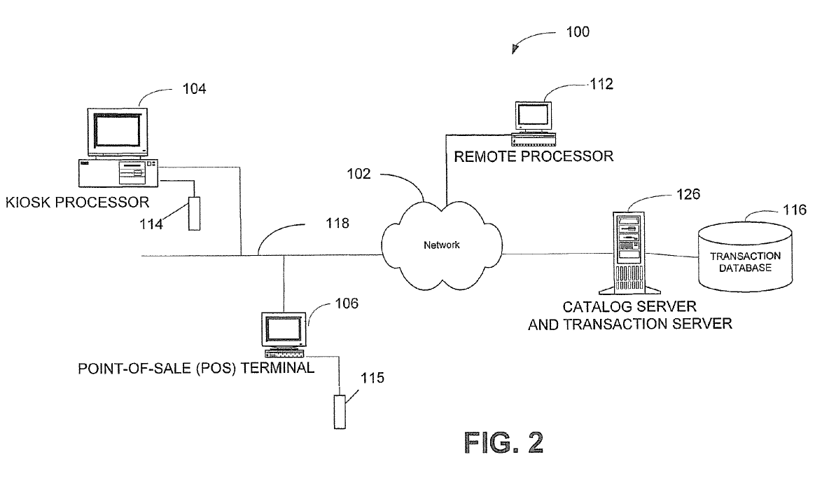

Referring now to FIG. 2, a functional network diagram of a first alternative embodiment is shown. As with the preferred embodiment shown in FIG. 1, the network 102 may have various connected components including a kiosk processor 104, a point-of-sale (POS) terminal 106, a transaction server 108, and/or a remote processor 112. In this embodiment, there is a combination catalog server and transaction server 126 that performs both functions and is connected to the network 102. The network 102 may include a local area network (LAN), a wide area network (WAN) or other networks including a global computer network, e.g., Internet. Moreover, the combination catalog server and transaction server 126 with an associated payment database 116 can be combined with servers or processors associated with the catalog provider or an entity associated with the transaction service provider. Therefore, when a catalog server 110 is referenced throughout this patent application, it references a server that is able to sell goods or services and there is absolutely no requirement that the server be owned, operated or even be associated with a catalog provider. Likewise, a catalog server 110 does not need to be operated on the physical location associated with a catalog provider. The catalog server 110 can be owned and operated by a catalog provider, a service provider, a retail establishment or some other third party. A catalog provider throughout this application is not restricted to goods and services provided by a catalog house but any party offering a listing of goods and/or services can be deemed a catalog provider.

The illustrated devices and components may also be connected through wireless interfaces without departing from the scope of the present invention.

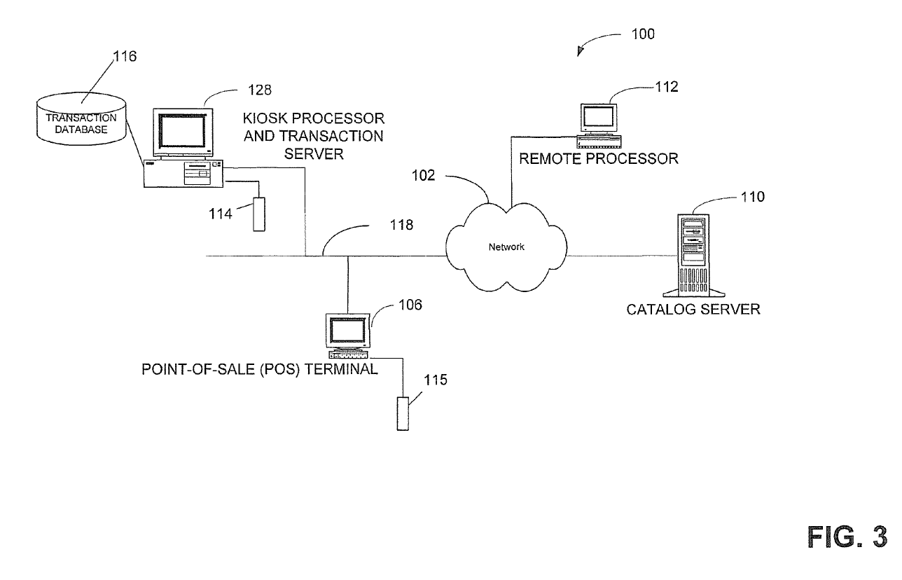

Referring now to FIG. 3, a functional network diagram of a second alternative embodiment is shown. As with the preferred embodiment shown in FIG. 1, the network 102 may have various connected components including a point-of-sale (POS) terminal 106, a transaction server 108, a catalog server 110, and/or a remote processor 112. In this embodiment, there is a combination kiosk processor and transaction server 128 that performs both functions and is connected to the network 102. The network 102 may include a local area network (LAN), a wide area network (WAN) or other networks including a global computer network, e.g., Internet. Moreover, the combination kiosk processor and transaction server 128 with an associated payment database 116 can be combined with servers or processors associated with a retail establishment or an entity associated with the transaction service provider. Also, the catalog server 110 can be combined with either the combination kiosk processor and transaction server 128 since, as previously stated, the catalog server 110 is able to sell goods or services and there is absolutely no requirement that the catalog server 110 be owned, operated or even be associated with a catalog house.

The illustrated devices and components may also be connected through wireless interfaces without departing from the scope of the present invention.

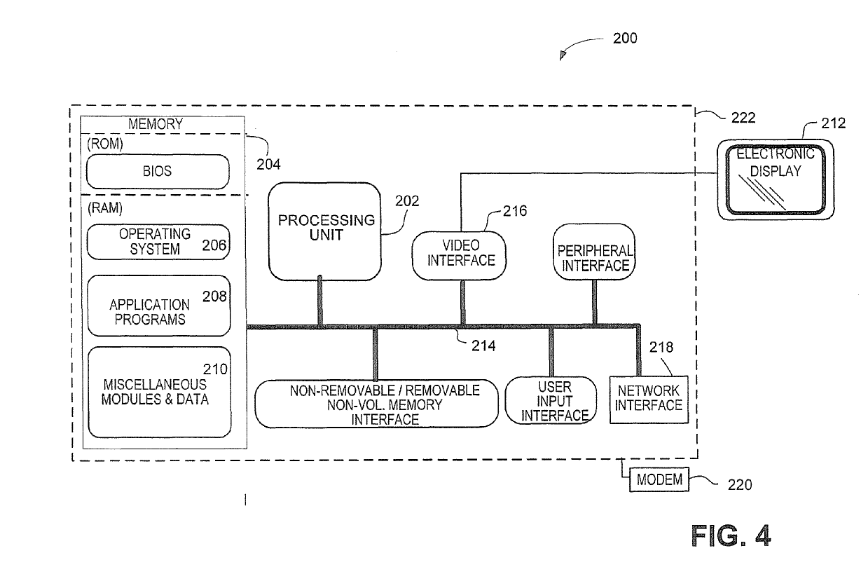

Those of ordinary skill in the art will also appreciate that there are several other components and interconnections present within a computing environment. Accordingly, additional details concerning the internal construction of the networked computing devices will not be discussed in connection with the present invention. However, an exemplary operating environment such as for the kiosk processor 104 or remote processor 112 is illustrated in FIG. 4 and discussed below.

With reference to FIG. 4, an exemplary system 200 for implementing the invention includes a general purpose computing device in the form of a processor is generally indicated by numeral 222 including a processing unit 202, a system memory 204, a video interface 216, a peripheral interface 217, a user input interface 219 and a system bus 214 that couples the various system components including the system memory 204 to the processing unit 222.

The processing unit 222 typically includes a variety of computer readable media, which may comprise computer storage media and communication media. The system memory 204 includes computer storage media in the form of volatile and/or nonvolatile memory such as read only memory (ROM) 203 and random access memory (RAM) 205. A basic input/output system (BIOS), containing the basic routines that help to transfer information between elements within the processing unit 222, such as during start-up, is typically stored in ROM 203. The RAM 205 typically contains data and/or program modules that are immediately accessible to and/or presently being operated on by the processing unit 222. For illustrative purposes, FIG. 4 depicts an operating system 206, application programs 208, and other miscellaneous program modules and data 210.

The processing unit 222 may also include other removable/non-removable, volatile/nonvolatile computer storage media, which is generally indicated by numeral 223. Such removable/non-removable, volatile/nonvolatile computer storage media 223 may include a hard disk drive, a magnetic disk drive, an optical disk drive, a CD-ROM or other optical media. Other removable/non-removable, volatile/nonvolatile computer storage media 223 that can be utilized include, but are not limited to, magnetic tape cassettes, flash memory cards, digital versatile disks, digital video tape, solid state RAM, solid state ROM, and the like.

The drives and their associated computer storage media 223 discussed above and illustrated in FIG. 4, provide storage of computer readable instructions, data structures, program modules and other data for the processing unit 222. A user may enter commands and information into the processing unit 222 through a variety of user input interface 219 including but not limited to a keyboard, magnetic stripped card reader, pointing device, scripting interface, a microphone, joystick, game pad, satellite dish, scanner, or the like. These and other input devices may be connected by other interface and bus structures, such as a parallel port, game port, fire-wire, infrared or a universal serial bus (USB).

An electronic display 212 or other type of display device is also connected to the system bus 214 via an interface, such as a video interface 216. Although a liquid crystal diode display is preferred for the electronic display 212, a cathode ray tube, a plasma screen and other types of electronic panel displays will suffice. The processing unit 222 may also include output devices such as speakers, printers, and the electronic display 212, which may be connected through a peripheral interface 217. As previously described, a network interface 218 may provide communication to a LAN, Internet or other network. A modem 220 may also be utilized to provide communication to a WAN or a global computer network, e.g., Internet.

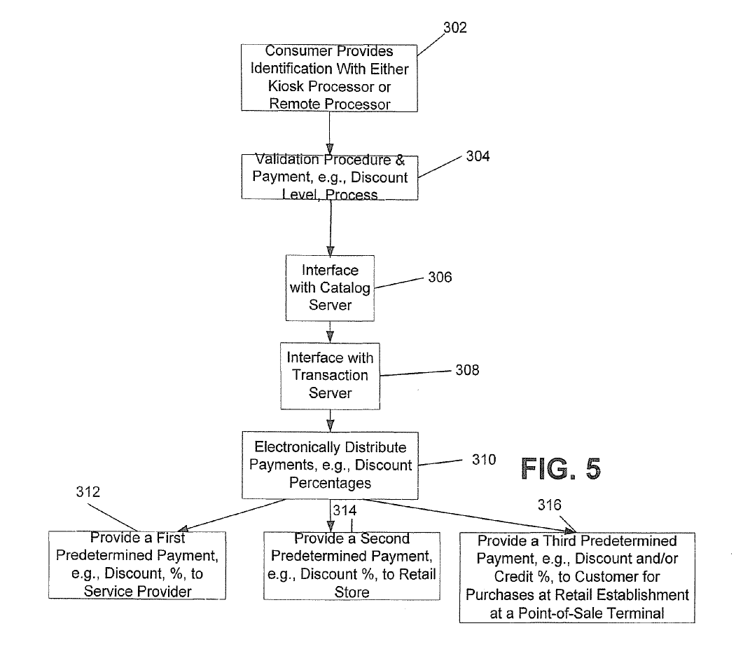

Having provided a broad overview and introduced the environment, devices and nomenclature, the process of the present invention can better be understood and will be discussed with reference to the flow diagram in FIG. 5.

Turning to FIG. 5, a flow diagram illustrates the process in a logic flow chart in an embodiment of the present invention with the functional explanation marked with numerals in angle brackets, <nnn>, will refer to the flowchart blocks bearing that number. As illustrated, a customer initially provides identification to the system at step <302>. As would be understood, such identification may be provided in any of a variety of ways, including but not limited to keyed entry with password, card reader entry, or biometric entry. As shown in FIG. 1, the customer may approach the kiosk processor 104 and utilize the electronic identification device, e.g., electronic card reader, keyboard for receiving an inputted password, and so forth, 114 to provide identification. Even further, the system into which such entry is provided may be, a kiosk processor 104 located at a retail establishment having a network connection 118 and/or point-of-sale (POS) terminal 106, as earlier described. The customer may also utilize a remote processor, e.g., personal computer, 112 at the customer's home that is connected to the global computer network, e.g., Internet, or network 102. In any case, returning to FIG. 5, such identification invokes a validation procedure as shown at step <304>.

Validation as used herein may include the verification of identity as well as a determination of a payment, e.g., discount, credit and/or debit level, associated with the identified customer or account. Even further, validation may include a determination of a preset payment value, e.g., discount, credit and/or debit, associated with the electronic card and/or inputted password. Alternatively, payment, e.g., discount, credit and/or debit levels, may be determined on the basis of purchase volumes, membership level, purchase of related goods and/or services, manufacturer promotions and so on.

Turning again to FIG. 1, validation occurs through communication with the transaction server 108, which has access to the payment database 116. Returning to FIG. 5, the customer will then interface with a catalog server 110, as shown in FIG. 1, in step <306>. Alternatively, the steps of validation and ascertaining the payment, e.g., discount, credit and/or debit level, can occur on the combination catalog server and transaction server 126, as shown in FIG. 2 or the combination kiosk processor and transaction server 128, as shown in FIG. 3.

After a purchase has been made from the catalog server 110, the next step <308> is to interface with the transaction server 108 to ascertain and distribute payments, e.g., discounts, credits and/or debits. As previously stated, the transaction server 108 can be combined with either the catalog server 110 and/or the kiosk processor 104 in the first and second alternative embodiments, respectively.

The next step is to electronically distribute the payment, e.g., discount, credit and/or debit, information or payment, e.g., discount, credit and/or debit percentage, <310>. Using the payment, e.g., discount, credit and/or debit level, information, the system and method of the present invention provides payment, e.g., discount, credit and/or debit, information or payment, e.g., discount, credit and/or debit percentage, to the retailer or catalog provider, at step <312>. The payment, e.g., discount, credit and/or debit, information may be applied to the customer's transaction and result in a first distribution of payments, e.g., discounts, credits and/or debits. Alternatively, the payment, e.g., discount, credit and/or debit, may be recorded and a credit would then be provided at a later date. For example, the customer may receive a credit after a predetermined period, e.g., thirty (30) days, after the initial purchase is made to make sure the transaction is complete and the ordered goods have not been returned. As an option, the retail establishment can earn interest and have use of the payment to the customer until the customer is able to make a purchase transaction after the predetermined period of time.

First, a total predetermined payment, e.g., discount, credit and/or debit of ten percent (10%), is determined. Preferably, but not necessarily, a first predetermined payment, e.g., discount, credit and/or debit of three percent (3%), of the total predetermined payment, e.g., discount, credit and/or debit of ten percent (10%), is distributed and/or credited, either electronically or otherwise, to a service provider that is responsible for the operation of the kiosks, transaction servers 108 and/or terminals <312>.

Preferably, but not necessarily, a second predetermined payment, e.g., discount, credit and/or debit of two percent (2%), of the total predetermined payment, e.g., discount, credit and/or debit of ten percent (10%), is distributed and/or credited, either electronically or otherwise, to at least one retail establishment, e.g., grocery store <314>.

Finally, preferably, but not necessarily, a third predetermined payment, e.g., discount, credit and/or debit of five percent (5%), of the total predetermined payment, e.g., discount, credit and/or debit of ten percent (10%), is distributed and/or credited to customer for purchases at a retail establishment by means of a point-of-sale (POS) terminal 106 <316>.

Alternatively, the activities performed by the service provider can be taken up by either the retail establishment or the catalog provider so that no distribution is needed to a service provider. Therefore, there will only be a first predetermined payment, e.g., discount, credit and/or debit of five percent (5%), of the total predetermined payment, e.g., discount, credit and/or debit of ten percent (10%), is distributed and/or credited, either electronically or otherwise, to the retail establishment, e.g., grocery store <314> and a second predetermined payment, e.g., discount, credit and/or debit of five percent (5%), of the total predetermined payment, e.g., discount, credit and/or debit of ten percent (10%), is distributed and/or credited to a customer for purchases at a retail establishment at a point-of-sale (POS) terminal 106 <316>.

In the event that purchase is occurring at a retail establishment, the system and method of the present system provides an interface into the retailer's point-of-sale (POS) terminal 106 of FIG. 1, at step <316>. Importantly, the distribution is electronically accomplished along with the extension of a payment and/or credit to the customer. Referring again to FIG. 1, once the purchases have been made by the customer through the kiosk processor 104 or the remote processor 112, from the catalog server 110, the payments, e.g., discounts, credits and/or debits, are preferably, but not necessarily, provided to the kiosk processor 104 after the appropriate predetermined time period, e.g., thirty (30) days. Optionally, the payment, e.g., discount, credit and/or debit, amounts can be applied to the electronic identification device, e.g., electronic card, inputted password, and so forth, 114. The customer will then make purchases at the retail establishment. At the point-of-sale (POS) terminal 106, the customer can utilize another electronic identification device, electronic card and/or inputted password, 115 so that the granted payments, e.g., discounts, credits and/or debits, can be applied to the customer's bill.

As a result of the system and method of the present invention, both customers and retailers need not worry about paper coupons, handling a myriad of payment, e.g., discount, credit and/or debit, cards or obtaining their respective payment, e.g., discount, credit and/or debit, percentages in a timely manner. An important and significant advantage of this invention is that the customer's purchasing power at both catalog houses and retail establishments is combined. This results in reduced prices for the customer at the retail establishment. It also provides retail establishments the ability to offer unrelated goods and make income therefrom to compete with mega/super retail stores. For the catalog houses, it allows them to have access to customers that may not notice them on the vast Internet and improves their marketing presence and visibility. Also, this provides an avenue for the catalog provider to compete with the mega/super retail stores.

Even further, the present invention enables the centralization of payment, e.g., discount, credit and/or debit, information while also providing a mechanism and methodology for the utilization and disbursement of payments, e.g., discounts, credits and/or debits. Further still, the present invention provides a method for a customer to access catalog houses, catalog providers or entities other than the one in whose establishment a kiosk is provided. Preferably, but not necessarily, a card with a magnetic strip or other electronic identification device 114, 115 may be utilized to provide access and interaction with the system and method of the present invention.

It would be understood by those skilled in the art that while certain functions are described as being performed on any one computing device, such functions may be performed in whole or in part by one or more systems individually or in collaboration across the network.

Although the preferred embodiment of the present invention and the method of using the same has been described in the foregoing specification with considerable details, it is to be understood that modifications may be made to the invention which do not exceed the scope of the appended claims and modified forms of the present invention done by others skilled in the art to which the invention pertains will be considered infringements of this invention when those modified forms fall within the claimed scope of this invention. A portion of the disclosure of this patent document contains material, which is subject to copyright protection. The copyright owner has no objection to the facsimile reproduction by any one of the patent document or the patent disclosure as it appears in the Patent and Trademark Office, Patent file or records, but otherwise reserves all copyright rights whatsoever.

1. (canceled)

2. A method of purchasing a product or service, the method comprising:
identifying a customer;
electronically validating the customer's identity;
electronically purchasing at least one first product or at least one first service from a first entity located at a first physical location with at least one first processor;
electronically ascertaining a predetermined payment to be made to at least two of a retailer, a service provider and the customer; and
electronically effecting distribution of the predetermined payment to at least two of the retailer, the service provider, and the customer.

3. The method of claim 2, wherein the at least one first processor includes a point-of-sale terminal.

4. The method of claim 2, further comprising electronically purchasing at least one second product or at least one second service from a second entity located at a second physical location.

5. The method of claim 4, wherein the electronically purchasing at least one second product or at least one second service from a second entity located at a second physical location is through at least one ordering mechanism physically located at a retail establishment at a first physical location.

6. The method of claim 5, wherein the at least one ordering mechanism includes at least one second processor.

7. The method of claim 5, wherein the at least one ordering mechanism includes at least one telephone.

8. The method of claim 6, wherein the at least one second processor is selected from the group consisting of a kiosk or a personal computer.

9. The method of claim 6, wherein the at least one second processor is electronically connected to a transaction database for electronically effecting distribution of the predetermined payment.

10. The method of claim 6, wherein the electronically purchasing at least one second product or at least one second service from a second entity located at a second physical location is through the at least one second processor physically located at a retail establishment at a first physical location that is in electronic communication with at least one third processor located at a second physical location.

11. The method of claim 10, wherein the at least one third processor includes at least one processor that lists a plurality of available items relating to the at least one second product or the at least one second service.

12. The method of claim 10, wherein the at least one third processor includes a catalog house server.

13. The method of claim 10, wherein the one third processor is electronically connected to a transaction database for electronically effecting distribution of the predetermined payment.

14. The method of claim 2, wherein the identifying a customer includes utilizing an identification mechanism.

15. The method of claim 14, wherein the identification mechanism is selected from the group consisting of an electronic card and a graphical user interface for receiving an inputted password.

16. The method of claim 2, wherein the predetermined payment is selected from the group consisting of a discount, a credit, a debit, or a purchase incentive.

17. The method of claim 2, further comprising waiting for a predetermined time after the transaction to distribute the predetermined payment.

18. The method of claim 2, wherein the retailer includes a grocery store.

19. The method of claim 2, wherein the distributing the predetermined payment includes distributing a first portion of the predetermined payment to the service provider that is involved in carrying out the transaction, distributing a second portion of the predetermined payment to the customer that is involved in the transaction, and distributing a third portion of the payment to the retailer.

20. A method of purchasing a product or service, the method comprising:
identifying a customer;
electronically validating the identity of the customer;
electronically purchasing at least one first product or at least one first service from a first entity located at a first physical location with at least one first processor;
electronically ascertaining a predetermined payment to be made to at least two of a retailer, a service provider, and the customer;
electronically effecting distribution of the predetermined payment to at least two of the retailer, the service provider and the customer; and
electronically purchasing at least one second product or at least one second service from a second entity located at a second physical location.

21. A system of purchasing a product or service with at least one processor, the system comprising:
an identification mechanism that identifies a customer and electronically validates an identity of the customer;
at least one ordering mechanism for electronically purchasing at least one first product or at least one first service from a first entity located at a first physical location; and
at least one second processor electronically connected to a transaction database for electronically ascertaining a predetermined payment to be made to at least two of a retailer, a service provider, and the customer and electronically effecting distribution of the predetermined payment to at least two of the retailer, the service provider, and the customer.

22. The system of claim 21, wherein the at least one first processor includes a point-of-sale terminal.

23. The system of claim 21, further comprising at least one ordering mechanism for electronically purchasing at least one second product or at least one second service from a second entity located at a second physical location.

24. The system of claim 23, wherein the at least one ordering mechanism is selected from the group consisting of at least one telephone, at least one second processor, at least one third processor or the at least one second processor in electronic communication with the at least one third processor.

25. The system of claim 24, wherein the at least one second processor is selected from the group consisting of a kiosk processor, a catalog house processor, or a personal computer.

26. The system of claim 21, wherein the identification mechanism is selected from the group consisting of an electronic card or a graphical user interface for receiving a password.

27. The system of claim 21, wherein the predetermined payment is selected from the group consisting of a discount, a credit, a debit, or a purchase incentive.

28. The system of claim 24, wherein the at least one second processor waits a predetermined time period after the transaction to distribute the predetermined payment.

29. The system of claim 21, wherein the retailer includes a grocery store.

30. A system of purchasing a product or service, the system comprising:
an identification mechanism that identifies a customer and electronically validates an identity of the customer;
at least one ordering mechanism for electronically purchasing at least one first product or at least one first service from a first entity located at a first physical location; and
at least one second processor electronically connected to at least one third processor for electronically purchasing at least one second product or at least one second service from a second entity located at a second physical location, wherein at least one of the second processor and the third processor is electronically connected to a transaction database for electronically ascertaining a predetermined payment to be made to at least two of a retailer, a service provider and the customer and electronically effecting distribution of the predetermined payment to at least two of the retailer, the service provider and the customer.
